(19) United States
(12) Patent Application Publication
(10) Pub. No.: US 2022/0097203 A1
(43) Pub. Date: Mar. 31, 2022

(54) CALIBRATION SYSTEM, CALIBRATION METHOD, AND CALIBRATION DEVICE

(71) Applicant: SHENZHENSHI YUZHAN PRECISION TECHNOLOGY CO., LTD., Shenzhen (CN)

(72) Inventors: YUAN-KUN YANG, New Taipei (TW); HAN-CHIEH CHANG, New Taipei (TW); CHUN-MING ZHONG, Shenzhen (CN); HAI-JUN LI, Shenzhen (CN)

(21) Appl. No.: 17/484,278

(22) Filed: Sep. 24, 2021

(30) Foreign Application Priority Data
Sep. 25, 2020 (CN) 202011027687.X

(51) Int. Cl. B24B 49/04; B23P 9/02; B24B 39/00

(52) U.S. Cl. CPC B24B 49/04; B24B 39/003; B23P 9/02

(57) ABSTRACT

A calibration system, a calibration method, and a calibration device configured to determine base information of a polish head to polish a workpiece through the polish head are provided. The base information comprises a first position. The calibration system includes the polish head, a controller, and a sensor group. The controller is coupled to the polish head and controls the polish head to move along a first direction. The sensor group detects a force that at least one of the polish head and the workpiece senses to generate a first pressure value. The controller determines whether the first pressure value is greater than a predetermined value. According to that the first pressure value is greater than the predetermined value, the first position is determined.

### CROSS-REFERENCE TO RELATED APPLICATIONS

This application claims priority to Chinese Patent Application No. 202011027687.X filed on Sep. 25, 2020 in China National Intellectual Property Administration, the contents of which are incorporated by reference herein.

### FIELD

The subject matter herein generally relates to manufacturing processes, and particularly to a calibration system, a calibration method, and a calibration device.

### BACKGROUND

In the field of manufacturing and processing, some workpieces need to be polished by a polishing device, so that a precise and predetermined surface of the workpiece can be obtained. A calibration of a polish head of the polishing device is important.

The calibration of a polish head mainly includes a calibration of an initial or starting point and a calibration of a surface posture, which determine a polishing precision.

In the traditional polishing process, the calibration of a polish head is operated manually, such as using a silicon steel sheet to measure a gap between a polish surface and a product by an operator as a determining standard of a polish head position. In another example, when the polish surface is a cambered surface or a hook face, the silicon steel sheet can only measure a point or a line of the surface, if the polish head is deflected, a calibration result may be affected, a fault in the polishing may occur, and yield of a satisfactorily-polished product may decrease.

Traditional calibration methods are affected by personal habit and different levels of experience, calibration errors may occur, and manual calibration also takes time, reducing efficiency.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic diagram of at least one embodiment of a calibration system.

FIG. 2 illustrates a diagrammatic view of at least one embodiment of a first calibration process of the calibration system.

FIG. 3 illustrates a diagrammatic view of at least one embodiment of the first calibration process of the calibration system from another angle.

FIG. 4 illustrates a diagrammatic view of at least one embodiment of a second calibration process of the calibration system.

FIG. 5 illustrates a diagrammatic view of at least one embodiment of the second calibration process of the calibration system from another angle.

FIG. 6 illustrates a diagrammatic view of at least one embodiment of a third calibration process of the calibration system.

FIG. 7 illustrates a diagrammatic view of at least one embodiment of the third calibration process of the calibration system from another angle.

FIG. 8 illustrates a diagrammatic view of at least one embodiment of a fourth calibration process of the calibration system.

FIG. 9 illustrates a diagrammatic view of at least one embodiment of the fourth calibration process of the calibration system from another angle.

FIG. 10 illustrates a diagrammatic view of at least one embodiment of the first calibration process of the calibration system from another angle.

FIG. 11 illustrates a flowchart of at least one embodiment of a first calibration method.

FIG. 12 illustrates a flowchart of at least one embodiment of a second calibration method.

FIG. 13 illustrates a flowchart of at least one embodiment of a third calibration method.

FIG. 14 illustrates a flowchart of at least one embodiment of a fourth calibration method.

FIG. 15 illustrates a schematic diagram of at least one embodiment of a holder of the calibration system.

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein but are not to be considered as limiting the scope of the embodiments.

Several definitions that apply throughout this disclosure will now be presented.

The term “coupled” is defined as connected, whether directly or indirectly through intervening components, and is not necessarily limited to physical connections. The term “substantially” is defined to be essentially conforming to the particular dimension, shape or other word that the term modifies, such that the component need not be exact. The term “comprising,” when utilized, means “including, but not necessarily limited to”; it specifically indicates open-ended inclusion or membership in the so-described combination, group, series and the like.

Before a polishing process, a corresponding position of a polish head 10 and a workpiece 12 (or tool of the workpiece 12) needs to be corrected, including an initial point calibration and a tool surface posture calibration. In a normal situation, a holder 80 remains, the polish head 10 needs to move in three-dimensions, which may cause a difference between a workpiece 12 (work) coordinate system and a tool surface (tool) coordinate system, unifying the work coordinate system and a world coordinate system is needed.

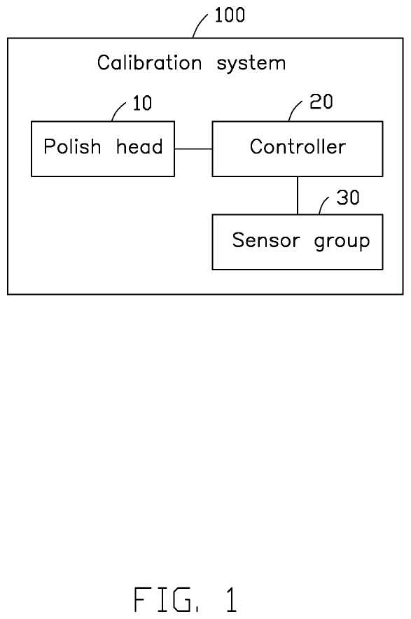

FIG. 1 illustrates a schematic diagram of at least one embodiment of a calibration system 100. The calibration system 100 is configured to determine base information of a polish head 10 to polish a workpiece 12 by the polish head 10. The base information includes a first position. The calibration system 100 includes the polish head 10, a controller 20, and a sensor group 30. The controller 20 is coupled to the polish head 10. The controller 20 is configured to control the polish head 10 to move along a first direction (for instance, an X-axis of a work coordinate system or a Z-axis of a tool coordinate system). The sensor group 30 is configured to, based on the polish head 10 moving along the first direction, detect at least one pressure on the polish head 10 or the workpiece 12 and generate a first pressure value. The sensor group 30 transmits the first pressure value to the controller 20. The controller 20 is configured to determine whether the first pressure value is greater than a predetermined value and determine the first position based on the first pressure value being greater than the predetermined value.

In another embodiment, the sensor group 30 is configured to detect a pressure on the polish head 10 and generate a first pressure value. The first direction can be any direction, as long as the polish head 10 and the workpiece 12 are moving along the first direction close to each other and the force therebetween reaches the first pressure value.

Furthermore, the first pressure value can be set according to actual demands, such as 1 kg.

Thus, by the pressure information of the polish head 10 and the workpiece 12, the initial position of the polish head 10 can be determined. The first direction and the predetermined value can be adjusted according to actual demands, to achieve real time force calibration, wide application scenario, easy to realize, simple structure, and high precision of calibration.

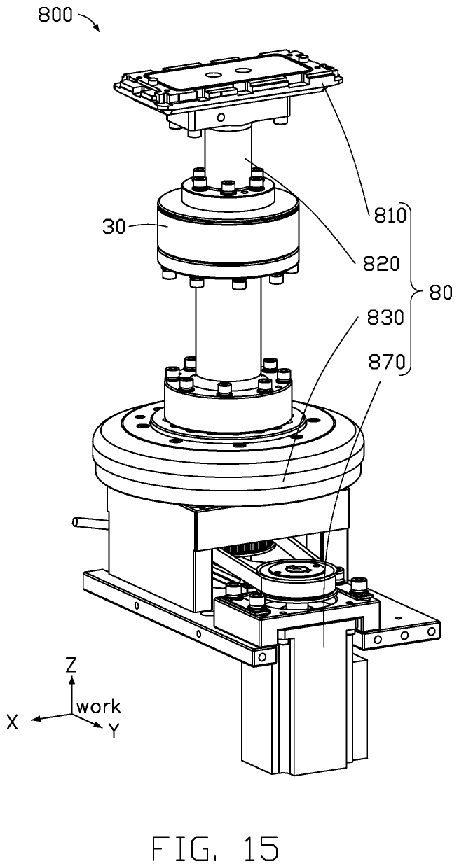

FIG. 15 illustrates a schematic diagram of at least one embodiment of a calibration device 800 including a holder 80 and the sensor group 30 coupled to each other.

In detail, the holder 80 includes a hold portion 810. The hold portion 810 is configured to grip the workpiece 12 and sense at least one of a force and a torque from the workpiece 12. The hold portion 810 can be a jig or a gripper for the workpiece 12. The sensor group 30 is configured to detect at least one of the force and the torque and generate a pressure value of the holder 80. The sensor group 30 can be a six-axis force sensor. The work coordinate system can be established based on the hold portion 810.

In another embodiment, the holder 80 can be a rotatable jig, which can drive the hold portion 810 to rotate.

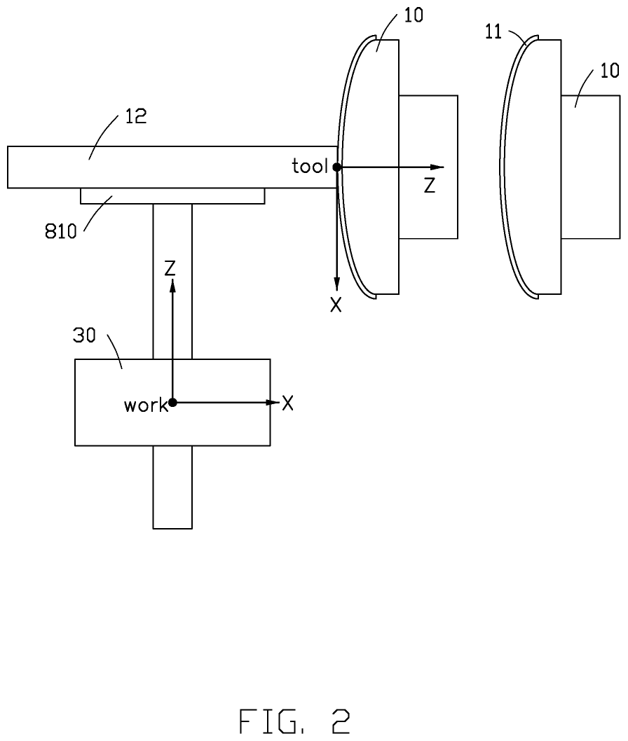

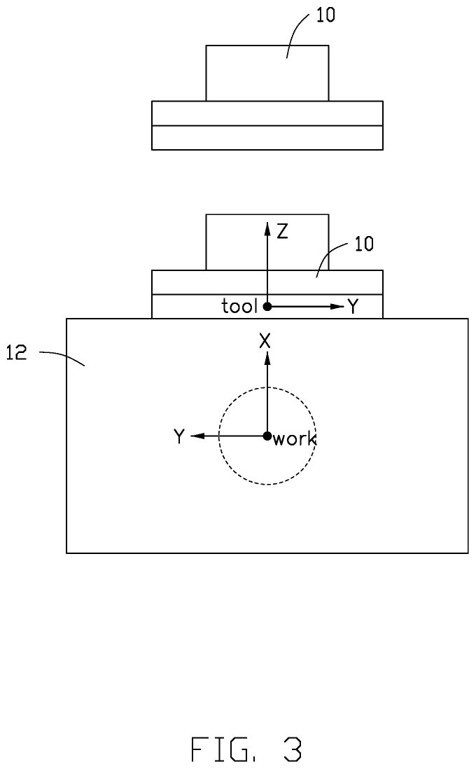

In at least one embodiment, referring to FIGS. 2 and 3, the polish head 10 is connected to a machine module (such as machine arm, not shown) or other devices for controlling the polish head 10. A tool coordinate system is established on the polish head 10. A polish arm drives the polish head 10 to move along the first direction (for instance, an X-axis of the work coordinate system or a Z-axis of the tool coordinate system), to bring the polish head 10 close to and resist against the hold portion 810 or the workpiece 12. The sensor group 30 detects a direct or indirect force on the hold portion 810 and generates a first pressure value (the figure shows an indirect force, but not limited as shown in the figure). The calibration system 100, based on the first pressure value is greater than the predetermined value, determines a position of the polish head 10, that being base information of the polish head 10. In other embodiment, the first direction can be other directions, such as a second direction along an X-axis of the tool coordinate system, a third direction along a Y-axis of the tool coordinate system, or any other direction. In the tool coordinate system, the X-axis, the Y-axis, and the Z-axis are perpendicular to each other. During the process, a corresponding relationship of the tool coordinate system and the work coordinate system can be: the X-axis, the Y-axis, and the Z-axis of the tool coordinate system are respectively corresponding to the Z-axis, the Y-axis, and the X-axis of the work coordinate system.

The base information includes an initial point of the polish head 10 and at least one posture of a polish surface of the polish head 10. The initial point can be a value of the polish head 10 pressing on the workpiece 12, such as a force corresponding to 1 kg. That is, before the polishing, an acting force of a resisting between the polish head 10 and the workpiece 12 is about 1 kg.

Thus, by adjusting the moving direction of the polish head 10, a direction of the acting force between the polish head 10 and the hold portion 810 can be adjusted. The sensor group 30 detects at least one of the force and the torque between the polish head 10 and the hold portion 810. The calibration device 800 determines the base information of the polish head 10 based on the pressure value.

In at least one embodiment, the hold portion 810 grips the workpiece 12, the polish head 10 moves along the first direction. The polish head 10 moves to and resists against the workpiece 12, the hold portion 810 senses at least one of a force and a torque from the polish head 10, the sensor group 30 detects at least one of the force and the torque of the hold portion 810, the calibration device 800 determines whether the pressure value is greater than the predetermined value. When the pressure value is greater than the predetermined value, the calibration device 800 determines that the position of the polish head 10 is the base information. Until then, the polish head 10 keeps moving along the first direction.

In another embodiment, the hold portion 810 does not grip the workpiece 12, the polish head 10 moves to and resists against the hold portion 810, the hold portion 810 directly senses at least one of the force and the torque from the polish head 10.

Further, a pressure range of the hold portion 810 is 0˜100 N. Through calculation, a pressure of the hold portion 810 during a correcting process is 1 kg, that is about 9.8 N. During the polishing process, a peak value of the force can be 10 kg, that is about 98 N. A safe margin is added, which makes a determination of the pressure range of the hold portion 810 as being within about 1˜100 N. The pressure range is configured to limit the acting force between the polish head 10 and the hold portion 810, preventing any damage caused by over pressure during the polishing process.

Referring to FIG. 15, in at least one embodiment, the holder 80 further includes a base 830 and a connecting portion 820. The connecting portion 820 is connected to the hold portion 810 and the base 830. The sensor group 30 is arranged on the connecting portion 820 and configured to detect at least one of the force and the torque, and generate a pressure value.

In another embodiment, the sensor group 30 can be arranged on the polish head 10 or between the polish head 10 and the hold portion 810, as long as the sensor group 30 can detect the acting force between the polish head 10 and the hold portion 810.

In at least one embodiment, the sensor group 30 can be a six-axis force sensor. The sensor group 30 can also be other types of sensor, as long as the sensor can detect the acting force between the polish head 10 and the hold portion 810.

Further, the holder 80 further includes a driver 870 arranged on the base 830 and connected to the connecting portion 820. The driver 870 is configured to rotate the connecting portion 820, to rotate the hold portion 810. The driver 870 can be an electric motor or a motor drive.

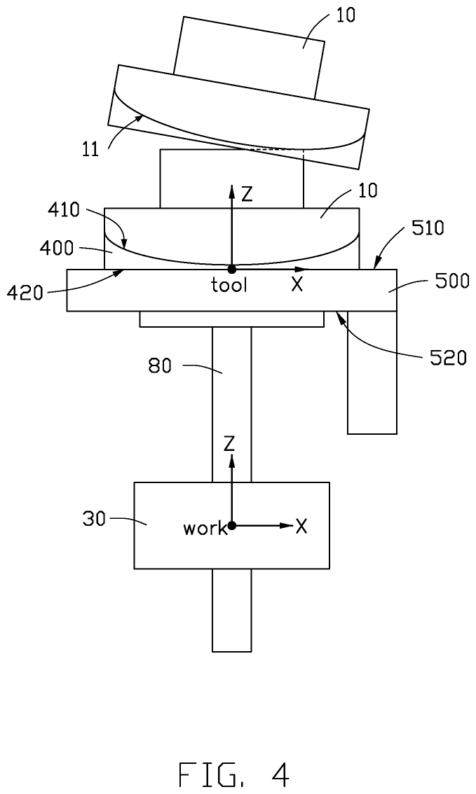

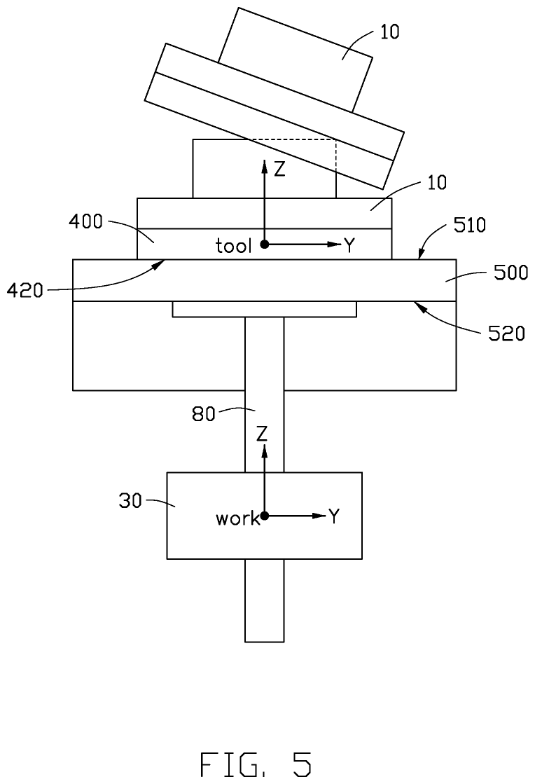

Further, referring to FIGS. 4 and 5, the polish head 10 includes a polish surface 11 connected to a first calibration block 400. The first calibration block 400 includes a first surface 410 and a second surface 420. The first surface 410 resists against the polish surface 11, the second surface 420 directly or indirectly resists against the hold portion 810. The first calibration block 400 is configured to sense at least one of a force and a torque by the first surface 410 and transmit the at least one of a force and a torque to the hold portion 810 by the second surface 420. The polish head 10 moves along the Z-axis of the tool coordinate system to resist against the second surface 420 against the hold portion 810. During the movement, the calibration can be the first posture of the polish head 10 along the X-axis of the tool coordinate system and the second posture of the polish head 10 along the Y-axis of the tool coordinate system. Comparing the calibration processes of FIGS. 2 and 3, the position and posture of the polish head 10 can be changed, and the tool coordinate system and the work coordinate system can be rearranged. The corresponding relationship of the tool coordinate system and the work coordinate system can be: the X-axis, the Y-axis, and the Z-axis of the tool coordinate system are corresponding to the X-axis, the Y-axis, and the Z-axis of the work coordinate system, not being limited.

Thus, by the first calibration block 400 engaging the polish head 10, the polish head 10 moves towards and resists against the hold portion 810. During the movement, the calibration of the first posture and the second posture of the polish head 10 is processed.

Further, the polish surface 11 and the first surface 410 are curved, a radius of curvature of the polish surface 11 is greater than a radius of curvature of the first surface 410. For instance, the radius of curvature of the polish surface 11 is about 60 cm, the radius of curvature of the first surface 410 is about 40 cm. Thus, since the radius of curvature of the polish surface 11 is greater than the radius of curvature of the first surface 410, the second surface 420 resists against the hold portion 810 when the polish head 10 drives the first calibration block 400, which causes the polish surface 11 resisting against the first surface 410. The polish surface 11 and the first surface 410 may not cause a slide, thereby achieving the posture calibration of the polish surface 11.

In another embodiment, the polish head 10 includes a polish surface 11 engaging with the first calibration block 400. The first calibration block 400 includes a secure portion (not shown) and a second surface 420. The secure portion is detachably connected to the polish head 10. The second surface 420 is directly or indirectly resisted against the hold portion 810. The first calibration block 400 is configured to bear at least one of the force and the torque from the polish head 10 through the secure portion. By transmitting the at least one of the force and the torque to the hold portion 810 being through the second surface 420 and by the secure portion detachably connected to the polish head 10, a connection of the first calibration block 400 and the polish head 10 may be achieve. In other embodiments, the secure portion is detachably connected to the polish head 10 through slots, mortise and tenon joint, stubs, or other ways. Thus, when the polish surface 11 and the first surface 410 are secured by the secure portion, corresponding positions of the polish surface 11 and the first surface 410 are determined. Thereby corresponding positions and postures of the polish head 10 and the holder 80 are determined, and further at least one of a second position, a first posture, and a second posture of the polish head 10 are determined.

Furthermore, the holder portion 810 is connected to a second calibration block 500, a main axis of the first calibration block 400 is in the first direction (such as the Z-axis of the work coordinate system or the Z-axis of the present work coordinate system). The second calibration block 500 includes a third surface 510 and a fourth surface 520. The third surface 510 resists against the second surface 420, the fourth surface 520 resists against the hold portion 810. The second calibration block 500 is configured to bear at least one of the force and the torque from the first calibration block 400 through the third surface 510. The force from the polish head 10 is transmitted to the hold portion 810 through the fourth surface 520.

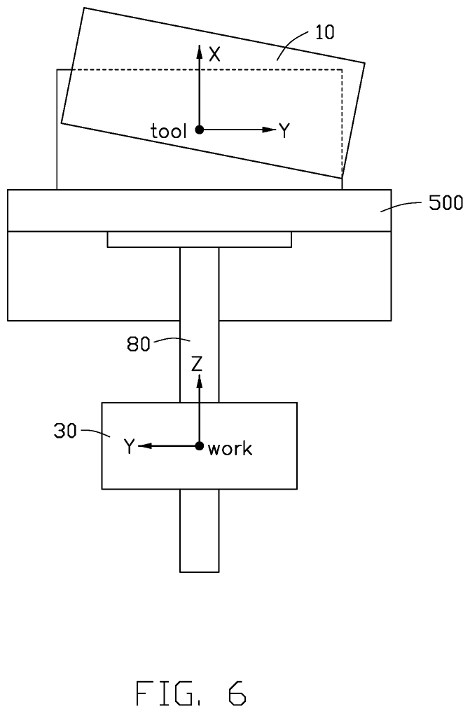

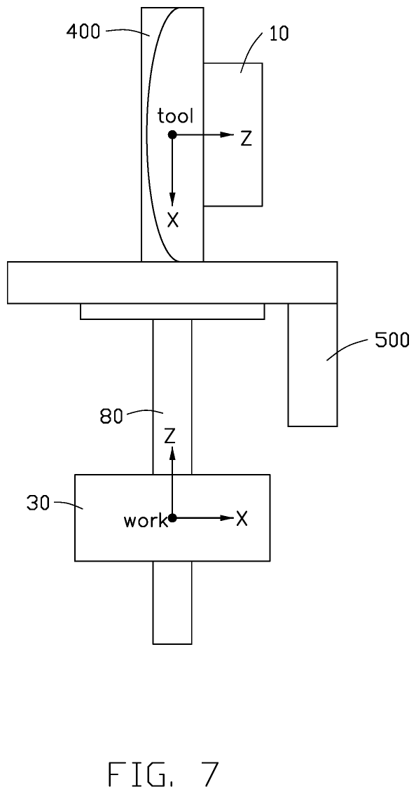

Referring to FIGS. 6 and 7, arranging the main axis of the first calibration block 400 on the first direction (the X-axis of the work coordinate system or the Z-axis of the tool coordinate system), the polish head 10 moves along the second direction (the Z-axis of the work coordinate system or the X-axis of the tool coordinate system), until the third surface 510 resists against a surface perpendicular to the second surface 420, and the fourth surface 520 resists against the hold portion 810. The third surface 510 senses the at least one of the force and the torque from the first calibration block 400, the fourth surface 520 transmits the force from the polish head 10 to the hold portion 810, to accomplish the calibration of the rotation of the polish head 10 related to the Z-axis of the tool coordinate system, that is the determination of the third posture.

Furthermore, the second surface 420 is planar to within 0.02 mm or less. The third surface 510 is planar to within 0.02 mm or less. The third surface 510 is parallel to the fourth surface 520, a depth of parallelism thereof is less than or equal to 0.01 mm. The fourth surface 520 is planar to within 0.02 mm or less.

Thus, through setting the flatness of the second surface 420, the third surface 510, and the fourth surface 520, when the polish head 10 moves, the acting force among the hold portion 810, the first calibration block 400, the second calibration block 500 is perpendicular to the second surface 420, the third surface 510, or the fourth surface 520, which facilitates posture calibration of the polish surface 11, and a calibration result is reliable.

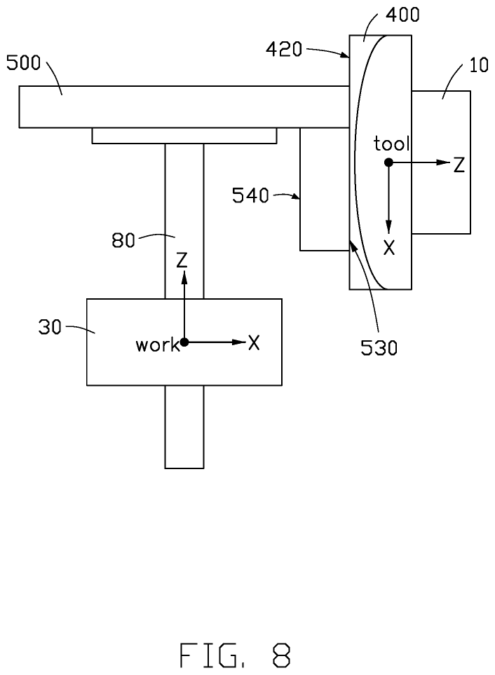

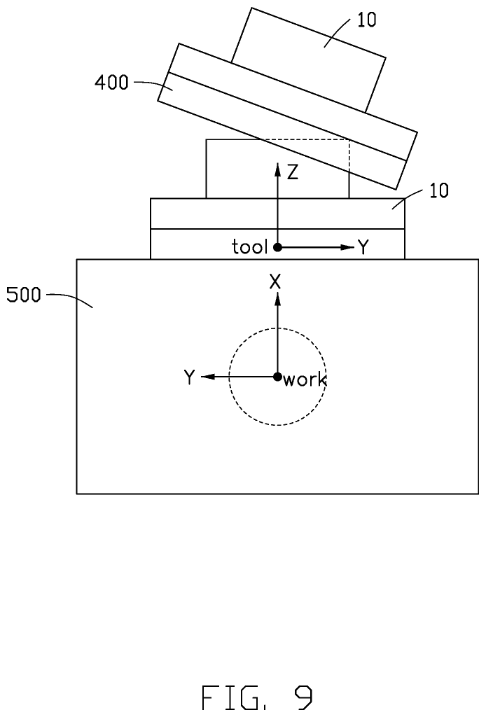

Furthermore, referring to FIGS. 8 and 9, arranging the main axis of the first calibration block 400 on the first direction (the X-axis of the work coordinate system or the Z-axis of the tool coordinate system), the second calibration block 500 further includes a fifth surface 530 and a sixth surface 540. The fifth surface 530 resists against the second surface 420, the sixth surface 540 resists against or faces against the hold portion 810. The second calibration block 500 further senses the at least one of the force and the torque from the first calibration block 400 through the fifth surface 530; and transmits the force from the polish head 10 to the hold portion 810 through the sixth surface 540. The sixth surface 540 resists against the hold portion 810 for directly transmitting the force from the polish head 10. The sixth surface 540 faces against the hold portion 810 for indirectly transmitting the force from the polish head 10 through a connecting structure (not shown) of the fourth surface 520.

Thus, through driving the polish head 10 along the Z-axis of the tool coordinate system, a further calibration of the polish head 10 posture along the Z-axis of the tool coordinate system (the X-axis of the work coordinate system) can take place. In verifying the calibration of polish head 10 through the first position, the second position, the first posture, the second posture, and the third posture, correct base information can be obtained. When the first posture, the second posture, and the third posture change after the calibration (such as visional deflection of the polish head 10 along the X-axis, the Y-axis, and the Z-axis of the tool coordinate system), the calibration must be repeated. When no changes, the calibration is complete.

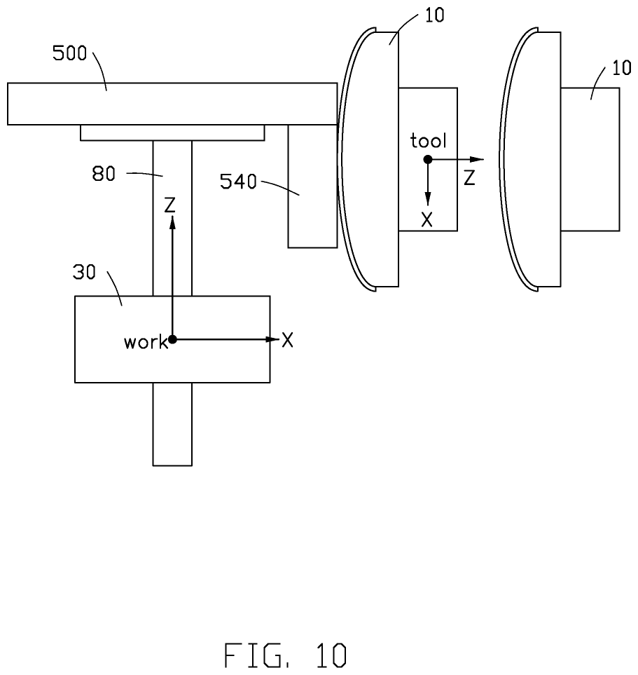

FIG. 10 illustrates a diagrammatic view of at least one embodiment of the calibration process of the calibration system from another angle. The hold portion 810 grips the second calibration block 500. The polish head 10 moves along the Z-axis of the tool coordinate system, until resisted by the fifth surface 530 of the second calibration block 500. The hold portion 810 indirectly senses the at least one of the force and the torque from the polish head 10. The sensor group 30 detects the at least one of the force and the torque sensed by the hold portion 810. The calibration device 800 determines whether the pressure value detected by the sensor group 30 is greater than the predetermined value. When the calibration device 800 determines that the pressure value detected by the sensor group 30 is greater than the predetermined value, the calibration device 800 determines that the current position of the polish head 10 is the base information. If not, the polish head 10 keeps moving along the Z-axis of the tool coordinate system.

Furthermore, the fifth surface 530 is planar to within 0.02 mm or less. The sixth surface 540 is planar to within 0.02 mm or less. The fifth surface 530 is parallel to the sixth surface 540, a depth of parallelism thereof is less than or equal to 0.01 mm. Thus, by setting the flatness of the fifth surface 530 and the sixth surface 540, when the polish head 10 moves, an acting force among the hold portion 810, the first calibration block 400, and the second calibration block 500 is perpendicular to the second surface 420, the third surface 510, or the fourth surface 520, for the calibration of the first position of the polish surface 11 of the polish head 10.

Referring to FIG. 1, a calibration process explaining the control of the system is as follows.

In a first aspect, the controller 20 is configured to control the polish head 10 to move along a first direction (for instance, an X-axis of the work coordinate system) to resist the polish head 10 against the workpiece 12. The sensor group 30, based on the polish head 10 moving along the first direction, detects at least one pressure on the polish head 10 or the workpiece 12 and generates a first pressure value. The sensor group 30 transmits the first pressure value to the controller 20. The controller 20 determines whether the first pressure value is greater than a predetermined value and determines the first position based on the first pressure value that is greater than the predetermined value. When the controller 20 determines that the first pressure value is greater than the predetermined value, the controller 20 stops the polish head 10, the position of the polish head 10 is the first position. When the controller 20 determines that the first pressure value is less than the predetermined value, the controller 20 keeps the polish head 10 moving along the first direction and continues receiving the first pressure value from the sensor group 30 until the first pressure value is greater than the predetermined value.

In at least one embodiment, referring to FIGS. 2 and 3, a calibration of the first position of the polish head 10 is shown. The controller 20 controls the polish head 10 to move along the X-axis of the work coordinate system to resist the polish surface 11 of the polish head 10 against a surface of the workpiece 12. The sensor group 30 detects the pressure on the workpiece 12 and transmits the pressure value to the controller 20. The controller 20 determines whether the pressure value is greater than the predetermined value. When the controller 20 determines that the pressure value is greater than the predetermined value, the controller 20 stops the polish head 10, the position of the polish head 10 being the first position. When the controller 20 determines that the pressure value is less than the predetermined value, the controller 20 keeps the polish head 10 moving. For instance, when the sensor group 30 detects the acting force between the workpiece 12 and the polish head 10 is 0.8 kg, which is less than the predetermined value of 1 kg, the controller 20 keeps the polish head 10 moving along the first direction, until the acting force is greater than 1 kg. Thus, the base information of the polish head 10 is determined by the controller 20 and the sensor group 30.

In at least one embodiment, the controller 20 includes a communicator, a processor, and a memory. The communicator is configured to establish communication with the sensor group 30 and transmit control instructions to the polish head 10 to control the movement of the polish head 10. The calibration process includes one or more computer program instructions stored in the memory and being processed by the processor to achieve the calibration function.

In at least one embodiment, the sensor group 30 includes a six-axis force sensor configured to detect the acting force between the workpiece 12 and the polish head 10.

In a second aspect, the calibration system 100 can be integrated in a machine arm. The controller 20 controls the polish head 10 to move along the first direction (such as the X-axis of the work coordinate system) to close and resist the polish head 10 against the workpiece 12. The controller 20 receives a first pressure value from the sensor group 30. The first pressure value is generated by a force sensed by at least one of the polish head 10 and the workpiece 12 detected by the sensor group 30 based on the polish head 10 moving along the first direction. The controller 20 determines whether the first pressure value is greater than a predetermined value and determines the first position based on the first pressure value that is greater than the predetermined value. When the controller 20 determines that the first pressure value is greater than the predetermined value, the controller 20 stops the polish head 10, the position of the polish head 10 is the first position. When the controller 20 determines that the first pressure value is less than the predetermined value, the controller 20 keeps the polish head 10 moving along the first direction and continues receiving the first pressure value from the sensor group 30 until the first pressure value is greater than the predetermined value.

In at least one embodiment, referring to FIGS. 2 and 3, the controller 20 controls the polish head 10 to move along the X-axis of the work coordinate system to resist the polish surface 11 of the polish head 10 against a surface of the workpiece 12. The controller 20 receives the pressure value from the sensor group 30. The pressure value can be the pressure that the workpiece 12 or the polish head 10 senses detected by the sensor group 30. The controller 20 determines whether the pressure value is greater than the predetermined value. When the controller 20 determines that the pressure value is greater than the predetermined value, the controller 20 stops the polish head 10, the position of the polish head 10 is the first position. When the controller 20 determines the pressure value is less than the predetermined value, the controller 20 keeps the polish head 10 moving and continues to receive the first pressure value transmitted by the sensor group 30 until the first pressure value is greater than the predetermined value.

Furthermore, the base information further includes a second position, a first posture (such as rotating along the X-axis of the tool coordinate system), and a second posture (such as rotating along the Y-axis of the tool coordinate system). The first direction is perpendicular to the second direction. The controller 20 is further configured to control the polish head 10 to move along the second direction. The sensor group 30 is further configured to, based on the polish head 10 moving along the second direction, detect a force that at least one of the polish head 10 and the workpiece 12 senses to generate a second pressure value. The controller 20 is further configured to determine whether the second pressure value is greater than the predetermined value, and determine at least one of the second position, the first posture, and the second posture based on the second pressure value that is greater than the predetermined value.

FIGS. 4 and 5 illustrate diagrammatic view of at least one embodiment of the calibration process of the polish head 10.

In a first aspect, the controller 20 controls the polish head 10 to move along the second direction (such as the Z-axis of the work coordinate system), to close and resist the polish surface 11 of the polish head 10 against a surface of the workpiece 12. The sensor group 30 detects a pressure that at least one of the polish head 10 and the workpiece 12 senses to generate a second pressure value. The sensor group 30 transmits the second pressure value to the controller 20. The controller 20 determines whether the second pressure value is greater than the predetermined value, and determines at least one of the second position, the first posture, and the second posture based on the second pressure value that is greater than the predetermined value. The controller 20 controls the polish head 10 to continuously move along the Z-axis of the work coordinate system, based on the second pressure value being less than the predetermined value.

In at least one embodiment, the second position can be a stopped position of the polish head 10 when the second pressure value is greater than the predetermined value. If the polish head 10 moving along the Z-axis of the work coordinate system is not rotated, that is, the posture of the polish head 10 is not changed, the first posture, the second posture, and the second position can be a same position. During the calibration process of the Z-axis of the work coordinate system, if the polish head 10 rotates relative to the X-axis of the tool coordinate system or the Y-axis of the tool coordinate system, the position after rotation can be the first posture and the second posture after calibration.

In a second aspect, the calibration system 100 can be integrated in a machine arm. The controller 20 controls the polish head 10 to move along the Z-axis of the work coordinate system to close and resist the polish surface 11 of the polish head 10 against a surface of the workpiece 12. The controller 20 receives the second pressure value from the sensor group 30. The second pressure value is generated by a pressure sensed by at least one of the polish head 10 and the workpiece 12 detected by the sensor group 30. The controller 20 determines whether the second pressure value is greater than a predetermined value. When the controller 20 determines that the second pressure value is greater than the predetermined value, the controller 20 controls the polish head 10 to stop. The position of the polish head 10 when stopped can be the second position, the first posture, and the second posture. When the controller 20 determines that the second pressure value is less than the predetermined value, the controller 20 controls the polish head 10 to continue to move along the second direction.

FIGS. 6 and 7 illustrate diagrammatic views of at least one embodiment of a calibration process of the polish head 10.

In a first aspect, the controller 20 adjusts the position of the polish head 10 to maintain the main axis of the polish head 10 in the first direction (such as the X-axis of the work coordinate system) and controls the polish head 10 to move along the second direction (such as the Z-axis of the work coordinate system). The sensor group 30, based on the polish head 10 moving along the Z-axis of the work coordinate system, detects a force that at least one of the polish head 10 or the workpiece 12 senses and generates a third pressure value. The sensor group 30 transmits the third pressure value to the controller 20. The controller 20 determines whether the third pressure value is greater than a predetermined value. When the controller 20 determines that the third pressure value is greater than the predetermined value, the controller 20 stops the polish head 10, the position of the stopped polish head 10 can be the first posture. When the controller 20 determines that the third pressure value is less than the predetermined value, the controller 20 controls the polish head 10 to continue to move along the Z-axis of the work coordinate system.

In a second aspect, the calibration system 100 can be integrated in a machine arm. The controller 20 adjusts the position of the polish head 10, to maintain the main axis of the polish head 10 in the X-axis of the work coordinate system and controls the polish head 10 to move along the Z-axis of the work coordinate system. The controller 20 receives the third pressure value from the sensor group 30. The third pressure value is generated based on the movement of the polish head 10 along the Z-axis of the work coordinate system, the force that at least one of the polish head 10 or the workpiece 12 senses as detected by sensor group 30. The controller 20 determines whether the third pressure value is greater than the predetermined value. When the controller 20 determines that the third pressure value is greater than the predetermined value, the controller 20 stops the polish head 10, the position of the stopped polish head 10 can be the third posture. When the controller 20 determines that the third pressure value is less than the predetermined value, the controller 20 controls the polish head 10 to continue to move along the Z-axis of the work coordinate system.

Thus, after calibration of at least one of the first position of the first direction and the second position of the second direction, the first posture, and the second posture, the position of the polish head 10 is adjusted to calibrate the base information of the polish head 10 or the workpiece 12 that senses forces in other directions, to determine the third posture of the polish head 10.

In at least one embodiment, the sensor group 30 is further configured to, based on the polish head 10 moving along the first direction, detect the force on the polish head 10 in the first direction, to generate the first pressure value.

In detail, the sensor group 30 can be mounted on the polish head 10, such as the sensor group 30 can be mounted on the machine arm, which is connected to the polish head 10. The sensor group 30 can detect the acting force that the polish head 10 senses when moving.

In another embodiment, the sensor group 30 is further configured to, based on the polish head 10 moving along the first direction, detect the force that the polish head 10 applies to the workpiece 12 along the first direction, to generate the first pressure value.

In detail, the sensor group 30 can be mounted between the polish head 10 and the workpiece 12, on the polish head 10, or on the holder 80 holding the workpiece 12. The sensor group 30 can directly or indirectly detect the acting force between the polish head 10 and the workpiece 12.

In another embodiment, the sensor group 30 is further configured to, based on the polish head 10 moving along the first direction, detect the force that the workpiece 12 senses in the first direction, to generate the first pressure value.

In detail, the sensor group 30 can be mounted on the holder 80, the hold portion 810 grips the workpiece 12, and when so gripped, the sensor group 30 detects the force received by the workpiece 12.

Furthermore, the controller 20 is further configured to adjust the polish head 10 to the first posture, and control the polish head 10 to move along the first direction. The sensor group 30 is further configured to, based on the polish head 10 moving along the first direction in the first posture, detect the force that at least one of the polish head 10 and the workpiece 12 senses, to generate the first pressure value.

Thus, the posture of the polish head 10 can be adjusted before determining the base information of the polish head 10, to avoid any fracture of the workpiece 12 or the polish head 10 suddenly applying force during the calibration process.

For instance, if the workpiece 12 is made of fragile material (such as glass), adjusting the posture of the polish head 10 before calibration speeds up the calibration of the base information, and avoids fracture of the workpiece 12 caused by impulses or sudden movements generated by fast movement of the polish head 10.

In at least one embodiment, FIGS. 8 and 9 illustrate diagrammatic views of at least one embodiment of a calibration process of the polish head 10.

In a first aspect, for verifying the calibration result, the controller 20 controls the polish head 10 in the first position, determines whether the main axis of the polish head 10 is in the first direction, and if not, readjusting; if yes, the calibration is finished.

In a second aspect, the calibration system 100 can be integrated in a machine arm, for verifying the calibration result, the controller 20 controls the polish head 10 in the first position, determines whether the main axis of the polish head 10 is in the first direction, if not, readjusting; if yes, the calibration is finished.

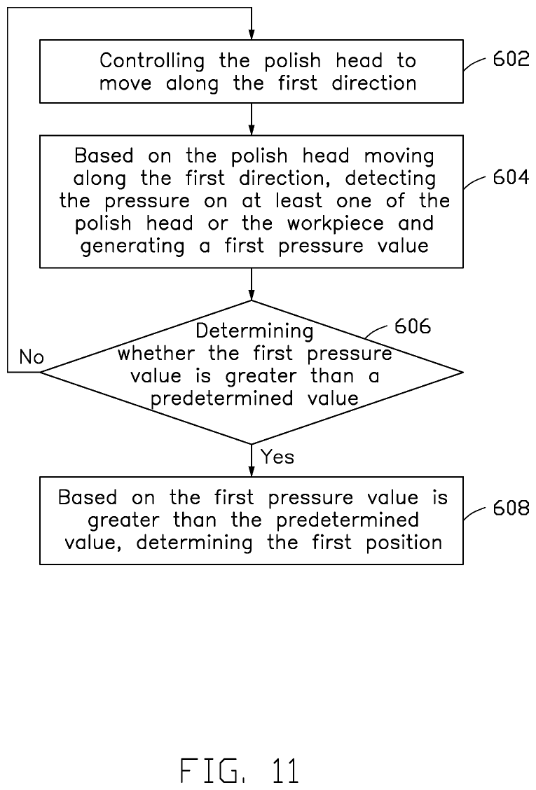

FIG. 11 illustrates a flowchart of at least one embodiment of a calibration method applied in the calibration device 800. The calibration method determines the base information of the polish head 10, the base information includes the first position. The calibration method includes:

At block 602, controlling the polish head 10 to move along the first direction, for instance, the first direction can be an X-axis of the work coordinate system or a Z-axis of the tool coordinate system.

At block 604, based on the polish head 10 moving along the first direction, detecting the pressure on at least one of the polish head 10 or the workpiece 12 and generating a first pressure value.

In at least one embodiment, the polish head 10 is configured to polish the workpiece 12. The first pressure value can be the acting force of the touch and resist between the polish head 10 and the workpiece 12. By detecting the pressure on the polish head 10, the first pressure value is generated.

At block 606, determining whether the first pressure value is greater than a predetermined value.

When determining the first pressure value is greater than the predetermined value, at block 608, based on the first pressure value being greater than the predetermined value, determining the first position. The first pressure value can be set according to actual requirement, such as 1 kg.

Thus, by the pressure information of the polish head 10 and the workpiece 12, the initial position of the polish head 10 can be determined. The first direction and the predetermined value can be adjusted according to actual demands, to achieve real time force calibration, wide applicable scene, easy to realize, simple structure, and high calibration precise. The first direction can be any direction, as long as the polish head 10 and the workpiece 12 moving along the first direction close to each other and the force therebetween reaches the first pressure value.

When determining the first pressure value is less than the predetermined value, the calibration method returns to block 602.

In at least one embodiment, the block 604 of generating a first pressure value includes:

Based on the polish head 10 moving along the first direction, detecting a pressure on the polish head 10 along the first direction and generating a first pressure value.

In another embodiment, the block 604 of generating a first pressure value includes:

Based on the polish head 10 moving along the first direction, detecting the force that the polish head 10 applies to the workpiece 12 in the first direction and generating a first pressure value.

In another embodiment, the block 604 of generating a first pressure value includes:

Based on the polish head 10 moving along the first direction, detecting the force that the workpiece 12 senses in the first direction and generating a first pressure value.

In at least one embodiment, during the polish head 10 moving along the first direction, the polish head 10 closes and resists against the workpiece 12, the polish head 10 puts a force on the workpiece 12 in the first direction. The force in the first direction that the workpiece 12 senses and the force in the first direction on the polish head 10 is equivalent, which can be the acting force between the polish head 10 and the workpiece 12. By detecting one of the forces by the sensor group 30, the first pressure value is obtained.

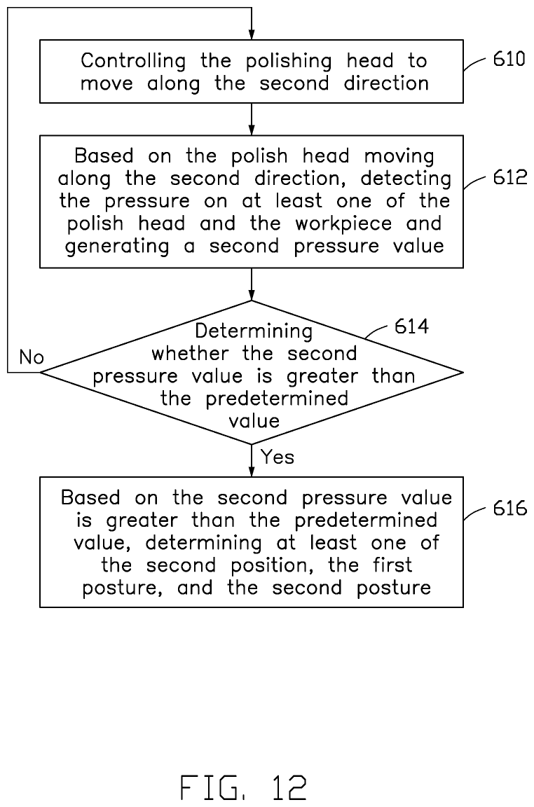

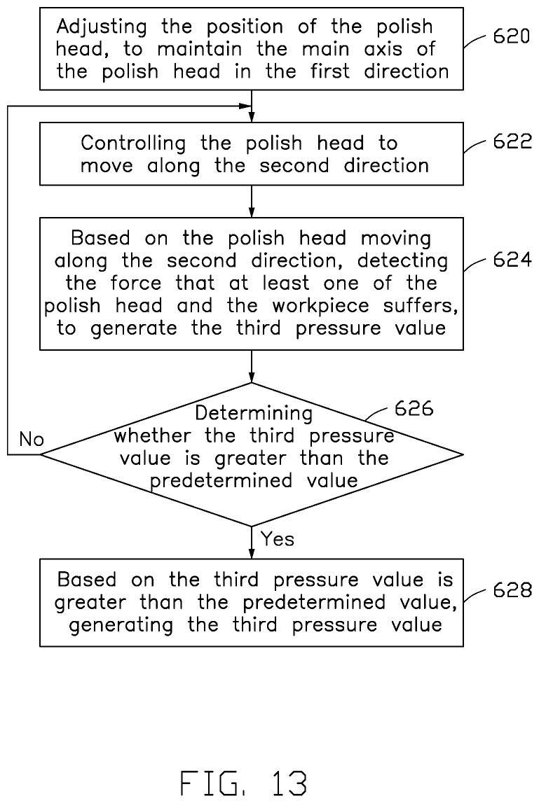

Furthermore, referring to FIG. 12, the base information includes a second position, a first posture, and a second posture. The first direction is perpendicular to the second direction. The first posture can be rotating relative to the X-axis of the tool coordinate system, the second posture can be rotating relative to the Y-axis of the tool coordinate system. Referring to FIG. 13, the calibration method further includes:

At block 610, controlling the polishing head 10 to move along the second direction. The second direction can be the Z-axis of the tool coordinate system.

At block 612, based on the polish head 10 moving along the second direction, detecting the pressure on the at least one of the polish head 10 and the workpiece 12 and generating a second pressure value.

At block 614, determining whether the second pressure value is greater than the predetermined value.

When determining the second pressure value is greater than the predetermined value, at block 616, based on the second pressure value being greater than the predetermined value, determining at least one of the second position, the first posture, and the second posture.

When determining the second pressure value is less than the predetermined value, the calibration method returns to block 610.

Based on determining the base information of the polish head 10 along the first direction, at least one of a polish initial position, the first posture, and the second posture of the polish head 10 in the second direction may be determined according to the pressure information of the workpiece 12 or the polish head 10 in the second direction. The first posture and the second posture can be positions of the polish head 10 along the first direction and the second direction after calibration.

Furthermore, the base information includes a third posture, referring to FIG. 13, the calibration method further includes:

At block 620, adjusting the position of the polish head 10, to maintain the main axis of the polish head 10 in the first direction.

At block 622, controlling the polish head 10 to move along the second direction.

At block 624, based on the polish head 10 moving along the second direction, detecting the force that the at least one of the polish head 10 and the workpiece 12 senses, to generate the third pressure value.

At block 626, determining whether the third pressure value is greater than the predetermined value.

When determining that the third pressure value is greater than the predetermined value, at block 628, based on the third pressure value being greater than the predetermined value, generating the third posture.

When determining that the third pressure value is less than the predetermined value, the calibration method returns to block 620.

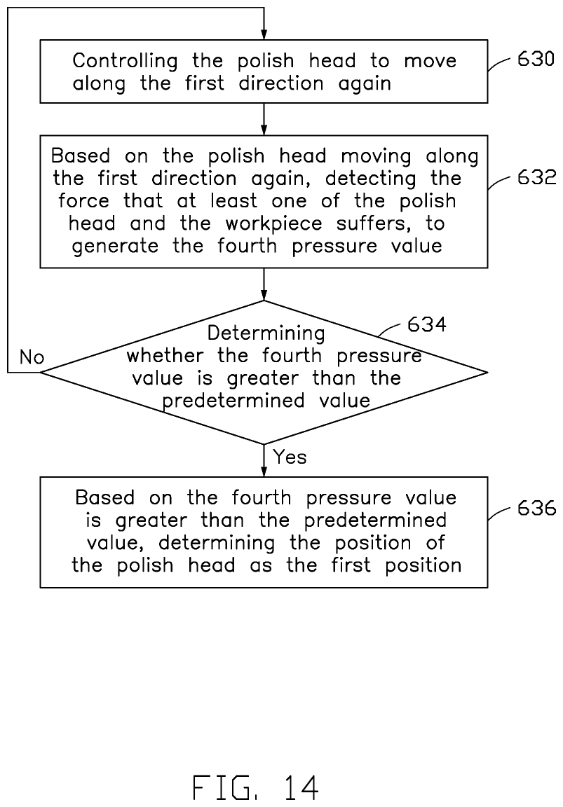

Referring to FIG. 14, the calibration method further includes:

At block 630, controlling the polish head 10 to move along the first direction again.

At block 632, based on the polish head 10 moving along the first direction again, detecting the force that the at least one of the polish head 10 and the workpiece 12 senses, to generate a fourth pressure value.

At block 634, determining whether the fourth pressure value is greater than the predetermined value.

When determining that the fourth pressure value is greater than the predetermined value, at block 636, based on the fourth pressure value being greater than the predetermined value, determining the position of the polish head 10 as the first position. For instance, when the sensor group 30 detects the acting force between the workpiece 12 and the polish head 10 is 0.8 kg, which is less than the predetermined value of 1 kg, the controller 20 keeps the polish head 10 moving along the first direction, until the acting force is greater 1 kg. Thus, determining the base information of the polish head 10 by the controller 20 and the sensor group 30.

Thus, according to process of driving the polish head 10 to move along the Z-axis of the tool coordinate system and generating the fourth pressure value, achieving another calibration of the posture of the polish head 10 along the Z-axis of the tool coordinate system, to verify the first position, the second position, the first posture, the second posture, and the third posture of the calibrated polish head 10 after calibration, to obtain the correction of the base information. If any obvious change raised after another calibration of the first posture, the second posture, and the third posture (such as visible shift of the polish head 10 relative to the X-axis, the Y-axis, or the Z-axis of the tool coordinate system), anew calibration is required. If no obvious change raised, the calibration finishes.

When determining that the fourth pressure value is less than the predetermined value, the calibration method returns to block 630.

The calibration system, the calibration method, and the calibration device can accomplish high precision calibration before a polishing process, determine the polishing initial position of the polish head 10 and the posture of the tool surface, determine the base information of the polish head 10, that is determining the base information of the machine arm controlling the polish head 10 or other controlling system. The calibration system, the calibration method, and the calibration device can calibrate polish surface of curved surface shaped or hook surface shaped, when polishing the workpiece 12 with a polish surface of curved surface shaped or hook surface shaped, a calibration error before polishing can be decreased, and polishing precision can be improved.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A calibration system configured to determine base information of a polish head to polish a workpiece through the polish head, the base information comprises a first position, the calibration system comprising:
the polish head;
a controller coupled to the polish head and configured to control the polish head to move along a first direction; and
a sensor group configured to generate a first pressure value, wherein according to the polish head moving along the first direction, the sensor group detect a force to generate the first pressure value, wherein the force is detected from at least one of the polish head and the workpiece senses;
wherein the controller is further configured to:
determine that the first pressure value is greater than a predetermined value; and
according to that the first pressure value is greater than the predetermined value, determine the first position.

2. The calibration system according to claim 1, wherein the base information further comprises a second position, a first posture, and a second posture,
the controller is further configured to control the polish head to move along a second direction perpendicular to the first direction, and
the sensor group is further configured to generate a second pressure value, wherein according to the polish head moving along the second direction, the sensor group detect a force to generate a second pressure value, wherein the force is detected from at least one of the polish head and the workpiece senses;
wherein the controller is further configured to:
determine that the second pressure value is greater than the predetermined value; and
according to that the second pressure value is greater than the predetermined value, determine at least one of the second position, the first posture, and the second posture.

3. The calibration system according to claim 2, wherein the base information further comprises a third posture,
the controller is further configured to:
adjust a position of the polish head, to maintain a main axis of the polish head in the first direction; and
control the polish head to move along the second direction, and
the sensor group is further configured to, according to that the polish head is moving along the second direction, detect a force that the at least one of the polish head and the workpiece senses, to generate a third pressure value,
wherein the controller is further configured to:
determine that the third pressure value is greater than the predetermined value; and
according to that the third pressure value is greater than the predetermined value, determine the third posture.

4. The calibration system according to claim 1, wherein the sensor group is further configured to:
according to that the polish head is moving along the first direction, detect a force along the first direction that the polish head senses, to generate the first pressure value.

5. The calibration system according to claim 1, wherein the sensor group is further configured to:
according to that the polish head is moving along the first direction, detect a force along the first direction that the polish head applies to the workpiece senses, to generate the first pressure value.

6. The calibration system according to claim 1, wherein the sensor group is further configured to:
according to that the polish head is moving along the first direction, detect a force along the first direction that the workpiece senses, to generate the first pressure value.

7. The calibration system according to claim 1, wherein
the controller is further configured to:
adjust a first posture of the polish head; and
control the polish head to move along the first direction;
the sensor group is further configured to:
based on the polish head moving along the first direction with the first posture, detect the force that the at least one of the polish head and the workpiece senses, to generate the first pressure value.

8. A calibration method configured to determine base information of a polish head to polish a workpiece through the polish head, the base information comprises a first position, the calibration method comprising:
controlling the polish head to move along a first direction;
according to that the polish head is moving along the first direction, detecting a force that at least one of the polish head and the workpiece senses, to generate a first pressure value,
determining that the first pressure value is greater than a predetermined value; and
according to that the first pressure value is greater than the predetermined value, determining the first position.

9. The calibration method according to claim 8, wherein the base information further comprises a second position, a first posture, and a second posture, the calibration method further comprises:
controlling the polish head to move along the second direction, wherein the second direction is perpendicular to the first direction;
according to that the polish head is moving along the second direction, detecting a force that the at least one of the polish head and the workpiece senses, to generate a second pressure value,
determining that the second pressure value is greater than the predetermined value; and
according to that the second pressure value is greater than the predetermined value, determining at least one of the second position, the first posture, and the second posture.

10. The calibration method according to claim 9, wherein the base information further comprises a third posture, the calibration method further comprises:
adjusting a position of the polish head, to maintain a main axis of the polish head in the first direction;
controlling the polish head to move along the second direction,
according to that the polish head is moving along the second direction, detecting a force that the at least one of the polish head and the workpiece senses, to generate a third pressure value,
determining that the third pressure value is greater than the predetermined value; and
according to that the third pressure value is greater than the predetermined value, determining the third posture.

11. The calibration method according to claim 10, further comprising:
controlling the polish head to move along the first direction again;
according to that the polish head is moving along the first direction again, detecting the force that at least one of the polish head and the workpiece senses, to generate a fourth pressure value;
determining that the fourth pressure value is greater than the predetermined value;
according to that the fourth pressure value is greater than the predetermined value, determining a present position of the polish head as the first position.

12. The calibration method according to claim 8, wherein the generating the first pressure value comprises:
according to that the polish head is moving along the first direction, detecting a force along the first direction that the polish head senses, to generate the first pressure value.

13. The calibration method according to claim 8, wherein the generating the first pressure value comprises:
according to that the polish head is moving along the first direction, detecting a force along the first direction that the polish head applies to the workpiece senses, to generate the first pressure value.

14. The calibration method according to claim 8, wherein the generating the first pressure value comprises:
according to that the polish head is moving along the first direction, detecting a force along the first direction that the workpiece senses, to generate the first pressure value.

15. A calibration system configured to determine base information of a polish head to polish a workpiece through the polish head, the base information comprises a first position, the calibration system comprising:
a controller coupled to the polish head and configured to control the polish head to move along a first direction and
receive a first pressure value from a sensor group, wherein the first pressure value is generated by a force that the at least one of the polish head and the workpiece senses, wherein the force detected by the sensor group according to that the polish head is moving along the first direction;
determine that the first pressure value is greater than a predetermined value; and
according to that the first pressure value is greater than the predetermined value, determine the first position.

16. The calibration system according to claim 15, wherein the base information further comprises a second position, a first posture, and a second posture,
the controller is further configured to:
control the polish head to move along the second direction wherein the second direction is perpendicular to the first direction, and
receive a second pressure value from the sensor group, wherein the second pressure value is generated by a force that the at least one of the polish head and the workpiece senses, wherein the force detected by the sensor group according to that the polish head moves along the second direction,
determine that the second pressure value is greater than the predetermined value; and
according to that the second pressure value is greater than the predetermined value, determine at least one of the second position, the first posture, and the second posture.

17. The calibration system according to claim 15, wherein the first pressure value is generated by a force along the first direction that the polish head senses, wherein the force is detected by the sensor group according to that the polish head is moving along the first direction.

18. The calibration system according to claim 15, wherein the first pressure value is generated by a force along the first direction that the polish head applies to the workpiece, wherein the force is detected by the sensor group according to that the polish head is moving along the first direction.

19. The calibration system according to claim 15, wherein the first pressure value is generated by a force along the first direction that the workpiece senses, wherein the force is detected by the sensor group according to that the polish head is moving along the first direction.

20. The calibration system according to claim 16, wherein the controller is further configured to:
adjust the first posture of the polish head;
control the polish head to move along the first direction; and
receive the first pressure value from the sensor group, wherein the first pressure value is generated by the force that the at least one of the polish head and the workpiece senses detected by the sensor group according to that the polish head moving along the first direction with the first posture.
